(19) United States
(12) Patent Application Publication
(10) Pub. No.: US 2016/0027021 A1
(43) Pub. Date: Jan. 28, 2016

(54) Product Authenticator

(71) Applicant: Andrew Kerdemelidis, London (GB)

(72) Inventor: Andrew Kerdemelidis, London (GB)

(21) Appl. No.: 14/339,465

(22) Filed: Jul. 24, 2014

(51) Int. Cl. G06Q 30/00

(52) U.S. Cl. CPC G06Q 30/018

(57) ABSTRACT

A product authenticator system and method for facilitating the verification of the authenticity of a product, by using a tamper-proof seal which either wholly or partially conceals an authentication code attached to a product. The said authentication code is unique and includes information which allows a user to verify the authenticity of the product. The authentication code can be scanned by a user using means such as a mobile phone, which can broadcast a notification of the consumption of the product via a computer network.

### FIELD OF THE INVENTION

The present invention relates generally to a product authenticator for facilitating the verification of authenticity of a product.

Particularly, but not exclusively, the invention relates to a product authenticator for facilitating the verification of authenticity of a product, said product authenticator including a tamper-proof seal which partially conceals an authentication code attached to a product.

### BACKGROUND OF THE INVENTION

Counterfeit products are a significant problem in various industries, particularly for highly priced products. Consumers of highly priced products have a need to ensure the products they consume are not counterfeit. For luxury goods, such consumption of genuine products provides a status signal for the consumer, which is eroded if the product is available as a cheap and/or low quality counterfeit or cannot be verified as genuine. There is also status value in providing notification to peers that a genuine luxury product has been purchased and/or consumed. For pharmaceutical products, there is a public health and safety aspect to ensure that pharmaceuticals are genuine, as counterfeit products could cause physical harm to a patient. Unfortunately, product counterfeiting remains a significant and growing problem due to increasing globalization and international trade channels. There is a need for a mechanism to facilitate the verification of authenticity of a product. There is also a need for a mechanism to track the time and place that a product is consumed, while facilitating the confirmation of authenticity of a product in a reliable manner.

Accordingly, it is an object of the present invention to provide a means for assisting a consumer to verify the authenticity of a product.

It is a further object of the present invention to allow a consumer to notify third parties of the time and place a product was consumed.

It is a further object of the present invention to provide a means for verifying the authenticity of a product, such means being resistant to tampering.

Further objects and advantages of the present invention will be disclosed and become apparent from the following description. These objects are to be read disjunctively with the object of at least providing the public with a useful choice.

### SUMMARY OF THE INVENTION

The present invention relates generally to a product authenticator for facilitating the verification of authenticity of a product.

According to a first aspect of the invention, there is provided a product authenticator for facilitating the verification of authenticity of a product, said product authenticator comprising:
a label for selling with a product, having a first side including a first authentication code unique to said product printed on the first side;
wherein said first authentication code is least partially concealed by a tamper evident seal;
wherein said tamper-evident seal can be removed to reveal the first authentication code;
wherein said first authentication code is configured such that reading all of said first authentication code with a scanning means uniquely identifies and verifies the authenticity of the product.

According to a second aspect of the invention, there is provided a method for facilitating the verification of authenticity of a product, said method comprising the steps of:
providing a label for selling with a product, said label having a first side including a first authentication code unique to said product printed on the first side, wherein said first authentication code is least partially concealed by a tamper evident seal;
removing tamper-evident seal to reveal the first authentication code;
reading all of said first authentication code using means for uniquely identifying and verifying the authenticity of the product.

Preferably, said tamper-evident seal is arranged and configured such that can only be removed when the product is consumed.

Preferably, said tamper evident seal includes an obfuscation pattern to at least partially obfuscate the first authentication code.

Preferably, said first side of the label includes an imprinting sensitive layer which is configured to allow printing of said first authentication code onto said first side without removing the tamper evident seal, wherein said imprinting is achieved by applying an imprinting means adjacent to the said first side of the label.

Preferably, said imprinting sensitive layer comprises a heat or pressure sensitive layer and said imprinting means comprises heat or pressure, respectively.

Preferably, said tamper evident seal comprises packaging enclosing said product and removal of the packaging is required to consume the product.

Preferably, said product comprises an enclosure having an opening and said label and tamper evident seal comprise a removable lid sealingly engaged with said opening, wherein said first authentication code is printed on the underside of said lid.

Alternatively, said label and tamper evident seal comprise a security seal wherein breaking the seal reveals said first authentication code.

Alternatively, said tamper evident seal comprises a peelable adhesive layer

Alternatively, said tamper evident seal comprises a scratchable removable layer.

Preferably, said first authentication code comprises data which resolves to a unique product identification code for the product.

Preferably, said unique product identification code comprises data which resolves to a unique URL (Uniform Resource Locator) that is of a minimum length such that it is prohibitively difficult to calculate or predict by brute-force methods.

Preferably, said first authentication code is configured to be readable by a scanning means including a smartphone camera, a laser scanner, digital camera, line-scan camera or other image digitising source, and to be sent directly to a decoding server via the Internet.

Preferably, said first authentication code comprises a 2-D barcode,

Alternatively, said first authentication code comprises a 1-D barcode,

Alternatively, said label includes a second side, wherein a second authentication code is printed on said second side, said second side being revealed on the exterior surface of the product wherein the first code and said second bar code are configured so in said reading all of said second bar code provides information about the product.

Preferably, said label is attached to the product, such that tamper proof seal is removable.

Alternatively, said label is permanently attached to the product, such that tamper proof seal is removable.

According to a third aspect of the invention, there is provided a system for facilitating the verification of authenticity of a product, said system comprising:
a product authenticator as referred to in the first aspect of the invention above;
scanning means configured to read said first product authentication code, said scanning means including means for communicating with a computer network;
a server connected to scanning means over the computer network, said server configured to receive first product authentication code data from scanning means and identify and verify the authenticity of the product.

Preferably, said computer network comprises the Internet.

Preferably, the server receiving first product authentication code data from scanning means results in the expiry of said first product authentication code, such that if the server subsequently received the same first product authentication code, the server sends a notification that the first authentication code has expired.

Preferably, the scanning means is configured to receive and provide the notification to a user of the scanning means.

Preferably, said scanning means is associated with a user and is configured to send user-specific information to said server upon reading said first product authentication code, wherein said server utilises said user-specific information to create a unique marketing profile for the user.

Preferably, said user-specific information comprises an IP address, user credentials, and social network credentials.

Preferably said server is configured to send predetermined marking information to a user according to the unique marketing profile for the user.

Preferably said scanning means is configured to send location data regarding the location of the scanning means to the decoding server once a first product authentication code has been read.

Preferably, said server is configured to record the time and date the location data was received.

Preferably, said location data comprises global positioning system (GPS) data such that tracking of location and consumption of said product is facilitated.

Preferably, scanning means comprises a communication device having a processor and a digital camera connected to the processor, such that, in use, a user takes a digital image of the first product authentication code and the processor sends said digital image to a server for authentication.

Preferably, said scanning means is configured to allow a user to input a review of the product once a first product authentication code has been read.

Preferably, said scanning means is configured to notify a user if a first product authentication code has previously been read.

Preferably, said communication device is configured to share on a computer network the fact that a product has been consumed by the user once a first product authentication code has been read.

Preferably, said computer network comprises a social network including personal connections of a user, and the fact that a product has been consumed by the user is shared with the personal connections of a user only.

Preferably, said communication device is configured to locate communication devices owned by other personal connections of a user within a pre-determined range and share on a social network which personal connections were within a pre-determined range when a first product authentication code has been read.

Preferably, said scanning means is configured to allow a user to enter a promotional contest once a first product authentication code has been read.

More specific features for preferred embodiments are set out in the description below.

### BRIEF DESCRIPTION OF THE DRAWINGS

The invention will now be described by way of example only with reference to the accompanying drawings, in which:

FIG. 1a shows a side sectional view of a product with the product authenticator comprising a lid according to an embodiment of the invention.

FIG. 1b shows an underneath view of the product authenticator comprising a lid according to an embodiment of the invention

FIG. 2a shows a side view of a product with the product authenticator comprising an adhesive label according to an embodiment of the invention.

FIG. 2b shows a side view of a product with the product authenticator comprising an adhesive label with peelable tamper proof seal partially removed according to a preferred embodiment of the invention.

FIG. 2c shows a plan view of the product authenticator comprising a label with a scratchable tamper proof seal.

FIG. 3 shows a perspective view of the product authenticator inside a product packaging according to an alternative embodiment of the invention.

FIG. 4 shows a system according to a preferred embodiment of the invention.

FIG. 5 shows a product authentication code according to an embodiment of the invention.

FIG. 6 is a flowchart showing a process for authenticating a product according to an embodiment of the invention.

### DETAILED DESCRIPTION OF THE INVENTION

Various embodiments of the present invention are described hereinafter with reference to the figures. It should be noted that the figures are only intended to facilitate the description of specific embodiments of the invention. In addition, an aspect described in conjunction with a particular embodiment of the present invention is not necessarily limited to that embodiment and can be practiced in any other embodiments of the present invention.

The present invention relates generally to a product authenticator for facilitating the verification of authenticity of a product.

Particularly, but not exclusively, the invention relates to a product authenticator for facilitating the verification of authenticity of a product, said product authenticator including a tamper-proof seal which partially conceals an authentication code attached to a product.

In accordance with a preferred embodiment the method and system is implemented via software running on a handheld scanning device such as a personal smartphone configured for wireless communication with a computer network such as the Internet. The computer network comprises a series of computers which are remotely linked via communication channels and include processors configured to execute software programs, such as programs to authenticate a product based on a unique product identification code and to update information such as a verification of the consumption of a product to a consumer's social network. Websites are hosted on various servers which are linked on the computer network and can be searched and interacted with through web browsers. Specialised software which is configured to run on website browsers is called a web application. It will be understood by those skilled in the art that various web applications and locally installed programs can be configured to allow the viewing, processing and exchange of information. Each computer connected to the network typically includes human interface means for allowing real-time or asynchronous input and communication by users in remote locations, such as keyboards, touchscreens computer mice and cameras.

Preferably, the invention relates to a system comprising a concealed 2-D barcode, or identification number such as either a single or plurality of QR codes and/or alphanumeric text, that resides underneath a security seal, such as scratchable paint or peel-able thin film with a ‘void’ indicator or bottle-cap, printed on adhesive label or underneath packaging but securely concealed so that either a part of, or the whole of the code cannot be seen unless the package is opened or any safety-seal opened. Preferably, the barcode is readable by a smartphone camera, and resolves to a Unique Resource Identifier (URI) alphanumeric or binary code, or is captured by a laser scanner, digital camera, line-scan camera or other image digitising source, and sent directly to a decoding server via the Internet. The code is a unique URL (Uniform Resource Locator) that is difficult to guess or obtain by brute-force methods, and is able to be generated on-the-fly, or is provided as a pre-printed label or tag. A key aspect of the product authenticator is the need for the code to be concealed until the product is used and the code checked by the end-consumer. Once the code has been ‘read’, it is then marked as having been read and ‘voided’ (optionally, with a GPS location and time of where it was read) and cannot be copied or used to authenticate another item. This is useful for any enterprise that requires secure product authentication and/or tracking of where a product is eventually consumed—for example for ensuring medicines are not counterfeit, or a product is consumed where it is intended to be consumed. It is ultimately a mechanism for validating and authenticating a consumer's consumption of a genuine product. This may in turn allow benefits to the consumer—such as making a valid claim that they have indeed made a purchase of a genuine product, allowing the consumer to review the product, share the fact they have consumed the product on a social network, enter a competition or claim a special offer.

Furthermore, the removable label that conceals the security seal is designed to invoke curiosity by consumers who are using the product. It may indicate that there is a competition that can be entered by scanning the concealed security code, or that a user can ‘share’ a status update with a friend or a social network which may include their location, any pictures or information they may attach related to the use or consumption of the product (including ratings, authenticated reviews, confirmation of the purchase/enjoyment of the product, related products, other individuals who were present when you consumed or used the product).

The product authenticator uniquely identifies a product at the point of consumption using a native application or on-device browser, the camera, GPS location service of the device, and/or GeoIP location—i.e. where the item was scanned and consumed. This is used to show the producer exactly where and when their products are being consumed. The consumer of the product can also see if the code has already been scanned by anyone else. If the code was scanned by another user, at any time in the past, the user is prompted, and is able to notify the producer that the product may be a counterfeit item (if it was purchased as either new or second-hand), or that it had already been consumed or opened at an earlier time by another user.

The product authentication process itself is able to inform either/or a consumer or producer where the product was consumed, how many authentication checks were performed on the unique code, the current ‘owner’ or ultimate consumer of the product, the first time that the code was used, further information about the product such as any recall information, whether the product is ‘expired’, the purchaser of the product, any related invoices or tax receipts, marketing details and pictures/brochures, subscription and registration of consumption or use relating to any special offers or loyalty programs, help information (and online helpdesk access), poisons and hazardous information detail. It is possible to report items as damaged, obtain warranty information and register for warranty claims, register for updates and news, allow the producer to connect to the social networks of the person consuming the product to provide updates, allowing the consumer to ‘like’ or ‘tweet’ or otherwise socially share news of their consumption or purchase of an original product on their social networks, provide for general or unique-to-user special offers and news/content, allow ordering or re-ordering of the same product, or other products from the same company online. It is also possible to register and ‘transfer ownership’ of any product (with the permission of the original owner) so that it will become difficult to deal in stolen goods that are marked in any way with the authentication code, and allows for a secondary market for a product to develop, which can include the history of any previous owners or consumers of a product. In this particular use or embodiment which allows tracking of ownership, the code is permanently affixed or marked on the product itself, and it is this mark that is concealed below a security seal or within packaging or within the product enclosure in a way that only the original purchaser of the product can check the code and associate their details with it.

The product authenticator may be applied to any kind of consumable physical product if proof-of-origin or anti-counterfeiting measures are required. Each product authenticator is unique, and preferably comprises of a 2-d barcode such as a QR code, and/or number that resolves to a unique website address, it is simple to apply to almost all products. The decoded barcode URI includes a unique identifier, which is globally unique for each individual product item (so that any two identical product items would have different unique identifiers). The unique identifier is composed of a web URL or IP address, and a variable-length character alphanumeric character or binary sequence that, when scanned and sent to a central server over the Internet, mobile network or any other means, is able to be resolved from a look-up table or database and data associated with this unique variable subsequently retrieved from a data store which can identify product information such as: the producer of the product, the product category and model/item, date and GPS coordinates of the last look-up (or a notification that this was the first time/date the identifier was looked up). In addition to this, the following marketing information and functionality can be delivered, including pictures, videos and other digital documentation, contact telephone numbers, email addresses, distributor contact details, online re-ordering information, social network sharing or ‘like’ buttons or functionality that allows the consumption of a product to be micro-blogged to a user's online social networking accounts, and the ability to see (and connect through online or mobile social networking) with others who also own or have consumed the product, or the ability for a competition to be automatically entered.

In use, the product authentication code resolves to a URL (e.g.: http://www.genucode.com/gd9f93ikf3949dg9ed83j4ds). For example, the URI in the URL (which is in the above case “gd9f93ikf3949dg9ed83j4ds”) may be resolved by the server at www.genucode.com to obtain the following information:

<Last Code Check, and whether it was performed on the same device>
<Coordinates and Unique User ID of individual that made the Last
Code Check>
<Producer Name>
<Product Name>
<Produced At Date>
<Produced At Location>
<Distributed By>
<Contact Details>
<Marketing Information including multimedia images, videos, audio
documents and text>
<Information such as profile images and descriptions, videos, pictures
and text and data gleaned from the social networks of any users to have
submitted/shared their information along with their check of the code, or
other users who have ‘shared’ a status update of the product being
used, or who have tagged or otherwise connected the
unique code to their social network profile>

Other functionality which is delivered to the user scanning a unique code allows reporting of a suspected counterfeit item, and sharing a status update notification of the consumption or purchase of a product through social networking and micro-blogging websites. Social network status notifications may include links to images, video or text of the product, and the ability for a user checking a code for the first time to ‘share’ their consumption of the product. The opportunity to share a status update after checking the authenticity of the product is only allowed once. This means that subsequent users who try to send an update with the same code will not be able to—this is important since it maintains the authenticity of the experience that is being shared. For example, after a user checks the authenticity of an expensive bottle of wine and shares a status update on their social networks, whereas another user cannot do so.

Consumers can also use this code to post reviews of the product, provide direct feedback to the producer about the product quality, offer or respond to requests to participate in qualitative or quantitative research, or join an online community. Product authenticator labels can be printed on-demand or provided as pre-printed labels. On-demand printing can be performed using a concealed sensitive paper (preferably, pressure or thermal sensitive blueprint paper) or any other method which allows printing of a code underneath a tamper proof layer while said tamper proof layer is intact. In this way, the label can be printed together with the tamper proof layer and the code is imprinted into the surface directly, which has the benefit of additional security as it is not possible to read the code at the time the code is printed onto the sensitive paper, without removing the tamper proof layer. Preferably, the imprinting occurs over the top of the tamper proof layer, although it is also possible to print the code through the underside of the label (assuming the sensitive layer is on the opposite side). It will be apparent to those skilled in the art that other means for allowing imprinting of the code on the sensitive paper are possible, such as, but not limited to providing paper which is sensitive to chemicals, irradiation, or electromagnetic energy.

Alternatively, there can be two types of code, firstly, an initial ‘pre-verification’ code, which, preferably, is printed or visible on top of the concealing layer. Preferably the ‘pre-verification code’ shows that the label itself is genuine and relates to the product, and may also provide information about the origin of the product itself or indeed all other information about the product, including information submitted by other consumers of the product on social networks (other than providing the function of securely authenticating the product, since this can only be done by using the concealed code). The concealed code is able to be revealed by removing the security seal. There may also be an obfuscation pattern printed on the underside or outside of the removable label to further enhance the security of the label, and this label may also have a ‘checked/void’ statement or pattern when tampered with or removed.

If a user has been authenticated as having purchased the product, they may, if appropriate, also post a review. This is useful, since it means that only consumers of the product can post reviews, and then only at the time of checking the authenticity of and consuming the product (or within a short period thereof). It is possible to enable a leaderboard′ relating to the product—which consumer ate/purchased the most of a product, or uses the product the most, and where they consumed or used it. It is possible therefore to identify the biggest consumers or users of a product, including identifying consumers who influence their peers. If the consumer permits, by connecting to their social networks, monitor a users conversations about the product, gain valuable insight as to the social and geographic demographics of consumers that are using the product—but also bring identified key consumers in on any new product development or market research, allow consumers to share and release advertising and marketing campaigns to their peers and across their social networks, recognize consumers by giving them special offers or discounts or enter them into a loyalty scheme based on their usage of a product.

In a preferred embodiment of the invention, a secure globally unique identifier (GUID) or secure hash of length greater than 8 characters is rendered into a QR code image and registered into a central or distributed datastore. The GUID sets up a web service and/or URL that is accessible over the Internet (or any other digital network) that resolves the authentication-check page or web-service call. A thermal, laser, bubblejet, dot-matrix or other printer then prints the image directly onto a self-adhesive label, with or without the plain-text version of the GUID or secure hash. The label is then covered with a completely or partially opaque and/or patterned security covering such as ‘scratchable’ paint or by using a self-adhesive covering. It is then applied to the product packaging or product itself, or as a tag attached to the product.

The label can also be applied directly onto the package, so that the underside of the label is in contact with an opaque part of the product or product packaging, so that it is not possible to read or determine the image or plaintext contents of the security label. The security label may also incorporate a QR or other machine-readable code, or plaintext on the visible side of the label.

In an embodiment, upon a user checking the concealed portion of the security label with a QR reader on a digital device, they are directed to a unique URL location composed of a domain identifier or IP address which may include a generic or unique subdomain (the subdomain being either the whole or part of the GUID, or another unique identifier string), and/or includes the GUID post-pended to the URL. The unique location will only exist if the GUID or secure hash was registered into the central or distributed database, or if the secure hash resolves cryptographically upon checking (for example, against a Galois field of numbers, which can be calculated on-the-fly, which means that it is not necessary to store the secure GUID that is imprinted behind the secure label on the product). In this embodiment, when the GUID is checked, it is stored as a reference in a database against which it is possible to register the consumers details.

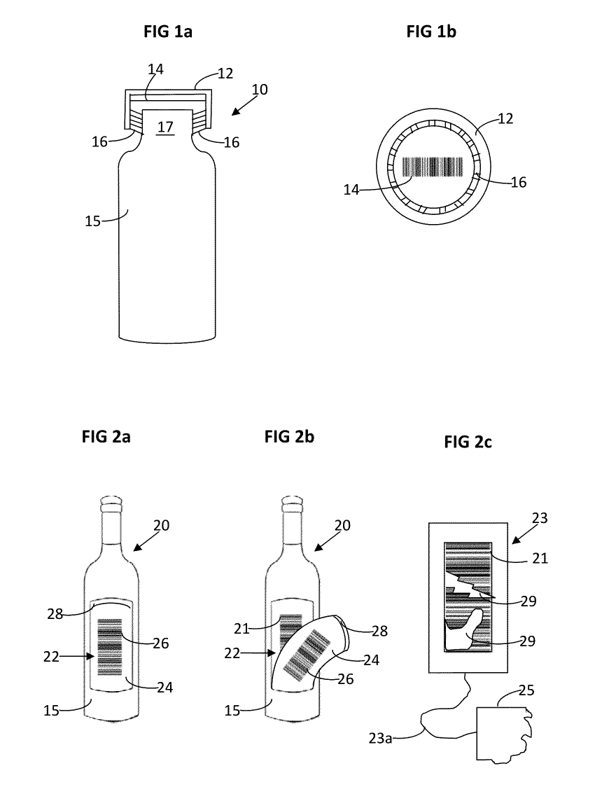

FIG. 1a shows a side view of a product 10 with the product authenticator comprising a lid 12 according to an embodiment of the invention. For example, the product can be bottle 15 of a luxury brand of spirits. The cap 12 has the product authentication code 14 printed on the underside of the cap. The cap has resilient tamper proof teeth 16 which comprise a seal that breaks when the cap 12 is opened. Preferably, the teeth are comprised of plastic. The cap may comprise another substance such as metal with the teeth 16 on the inner rim of the cap 12, which seals the outlet 17 of the bottle.

FIG. 1b shows an underneath view of the product authenticator comprising a lid 12 according to an embodiment of the invention. When the lid 12 is removed from the bottle 15 (not shown) by breaking the tamper proof teeth 16, the product authentication code 14 is visible. This code can be read by a scanner such as a camera on a smartphone operating the appropriate code reading software. Such code reading software is apparent to those skilled in the art. As described above, reading the code 14 will connect to a unique webpage which causes a server to communicate with the smartphone and verify the authenticity of the product. The server can also be configured to provide an update to a user's connections on their social network regarding the fact of consumption of the authentic spirits with the location of the user (e.g. at a particular nightclub venue) and/or provide marketing material to a user. The server can also be configured to detect a user's connections who are in the same location as the user (for example, using GPS signals from their respective smartphones) when consuming the product and update that information to the user's social network.

FIG. 2a shows a side view of a product 20 with the product authenticator comprising an adhesive label 22 according to an embodiment of the invention. In this particular embodiment the adhesive label 22 is attached to a bottle 15 and the outer layer of the adhesive label 22 is a peelable tamper proof seal 24 which has a second product authentication code 26 printed on it, allowing it to be read directly. Preferably, in use, this second product authentication code 26 provides general information about the product as described above. The peelable layer 24 has a tab 28 which allows it to be removed.

FIG. 2b shows a side view of a product with the product authenticator comprising an adhesive label 22 with peelable tamper proof seal 24 partially removed according to a preferred embodiment of the invention. The removal of the tamper proof seal 24 reveals a first product authentication code 21 which, when scanned, verifies the authenticity of the product being consumed in a one-off manner.

In an alternative embodiment, FIG. 2c shows a plan view of the product authenticator comprising a label 23 with a scratchable tamper proof seal 29. The label 23 is freely attached by a cord or string 23a to a product 25, such as an item of clothing 25. A user can use their nail or some resilient object to scratch the seal to remove it and view the product authentication code 21 underneath the scratchable layer 29.

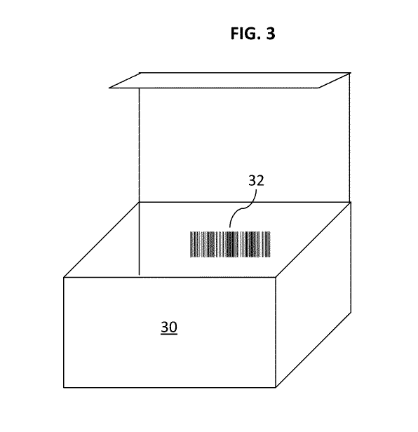

FIG. 3 shows a perspective view of the product authentication code 32 inside a product packaging 30 according to an alternative embodiment of the invention. A product (not shown) may be placed within the packaging, which is sealed in a tamper-proof manner. Essentially, the product packaging then comprises the tamper-proof seal, which reveals the product authentication code 32 when the package is opened. Once a consumer scans the product authentication code 32 with their smartphone (not shown) they can verify whether the product is genuine and/or receive promotional material.

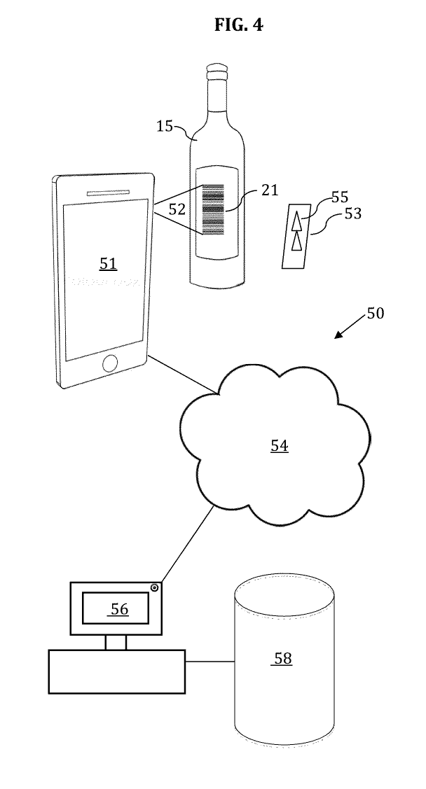

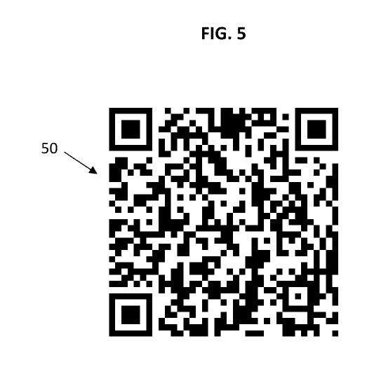

FIG. 4 shows a system 50 according to a preferred embodiment of the invention. A smartphone 51 is provided which scanning means 52, such as a camera, which is configured to scan the revealed product authentication code 21. A tamper proof seal 53 is removed from the product authentication code and discarded. In this embodiment, this seal 53 is a peelable adhesive layer, and may also include an obfuscation pattern 55 to prevent the product authentication code 21 from being read from beneath the tamper proof seal 53. Once the smartphone 51 scans the product authentication code, this is converted into data such as a URL which is connected to the smartphone 51 via the Internet 54. A server 56 runs the website connected to via the URL and retrieves the matching product identification code from the database 58 to identify the product. Preferably, the server also receives GPS data from the smartphone 51 to record the location of consumption and store that information in the database 58 along with other relevant user-specific information, including cookies. Preferably, the server 56 can be configured to post an update on the social network connections of the user verifying the consumption of the product, for example, posting a status update to followers on Twitter or friends on Facebook with location data.

FIG. 5 shows a product authentication code according to a preferred embodiment of the invention, wherein the product authentication code is a QR code or 2-D barcode 50. These 2-D barcodes are preferred as they can contain a much larger amount of data than a 1-D barcode. It will be apparent to those skilled in the art that alternative methods of storing a product authentication code in a manner that can be scanned after being revealed are possible. For example, a radio-frequency identification (RFID) tag (not shown) can conceivably include similar information. It could include means for activating the RFID tag once a tamper proof seal has been broken. For example, the tamper proof seal may be configured to interfere with electromagnetic wave transmission and therefore interfere with the ability of a scanner to detect an RFID signal.

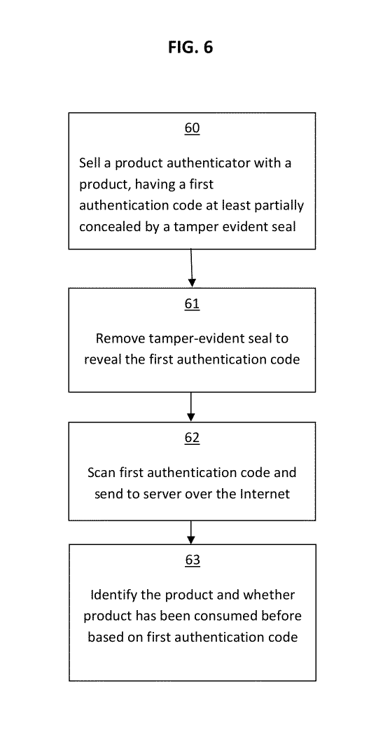

FIG. 6 shows a flowchart detailing a process for authenticating a product according to an embodiment of the invention. The first step 60 involves selling a product authenticator with a product. This can be included in the product packaging or attached to the product as a tag or adhesive layer. The next step 61 involves removing the tamper evident seal to reveal the first authentication code. As discussed above, the tamper proof seal can comprise various embodiments such as removable packaging, a peelable or scratchable layer, or some other obfuscation mechanism. The next step 62 involves scanning the authentication code and uploading that information via the Internet. The next step 63 involves using of the authentication code to identify the product and whether this has been consumed for the first time. As discussed above, preferably, this is accomplished with a server looking up the unique GUID of the product in a database.

It will be apparent to those skilled in the art that the product authenticator can be used in various embodiments and on various goods where authentication of a product as well as collecting information about the location and time of authentication is important. Such goods include pharmaceutical goods, which are particularly susceptible to counterfeiting. In such cases, the product authentication code can be placed underneath the cap of a container for the pharmaceuticals, or contained within the packaging. Other products requiring authentication include electronic goods such as external hard disks, memory sticks and other computer hardware. For such goods, the product authentication code may be permanently affixed to the product in some manner, such as attaching a label with permanent adhesive. Alternatively, the code can associated with the product via permanent etching or moulding. Alternatively, the code could be placed inside the product packaging.

While the invention has been illustrated and described in detail in the foregoing description, such illustration and description are to be considered illustrative or exemplary and non-restrictive; the invention is thus not limited to the disclosed embodiments. Features mentioned in connection with one embodiment described herein may also be advantageous as features of another embodiment described herein without explicitly showing these features. Variations to the disclosed embodiments can be understood and effected by those skilled in the art and practicing the claimed invention, from a study of the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A product authenticator for facilitating the verification of authenticity of a product, said product authenticator comprising:
a label for selling with a product, having a first side including a first authentication code unique to said product printed on the first side;
wherein said first authentication code is least partially concealed by a tamper evident seal;
wherein said tamper-evident seal is configured to be removable to reveal the first authentication code;
wherein said first authentication code is configured such that reading all of said first authentication code with a scanning means uniquely identifies and verifies the authenticity of the product.

2. The product authenticator of claim 1 wherein said tamper-evident seal is arranged and configured such that can only be removed when the product is consumed.

3. The product authenticator of claim 1 wherein said tamper evident seal comprises packaging enclosing said product.

4. The product authenticator of claim 1 wherein said tamper evident seal includes an obfuscation pattern to at least partially obfuscate the first authentication code.

5. The product authenticator of claim 1 wherein said first side of the label includes an imprinting sensitive layer which is configured to allow printing of said first authentication code onto said first side without removing the tamper evident seal, wherein said imprinting is achieved by applying an imprinting means adjacent to the said first side of the label.

6. The product authenticator of claim 5 wherein said imprinting sensitive layer comprises a heat or pressure sensitive layer and said imprinting means comprises heat or pressure, respectively.

7. The product authenticator of claim 1 wherein product comprises an enclosure having an opening and said label and tamper evident seal comprise a removable lid sealingly engaged with said opening, wherein said first authentication code is printed on the underside of said lid.

8. The product authenticator of claim 1 wherein said label and tamper evident seal comprise a security seal wherein breaking the seal reveals said first authentication code.

9. The product authenticator of claim 1 wherein said tamper evident seal comprises a peelable adhesive layer.

10. The product authenticator of claim 1 said tamper evident seal comprises a scratchable removable layer.

11. The product authenticator of claim 1 wherein said first authentication code comprises data which resolves to a unique product identification code for the product.

12. The product authenticator of claim 11 wherein said unique product identification code comprises data which resolves to a unique Uniform Resource Locator that is of a minimum length such that it is prohibitively difficult to calculate or predict by brute-force methods.

13. The product authenticator of claim 1 wherein said first authentication code comprises a 2-D barcode,

14. The product authenticator of claim 1 wherein said first authentication code comprises a 1-D barcode,

15. The product authenticator of claim 1, wherein said label includes a second side having a second authentication code displayed on the exterior surface of the product, wherein scanning said second authentication code provides information about the product.

16. The product authenticator of claim 1 wherein said label is permanently attached to the product.

17. A method for facilitating the verification of authenticity of a product, said method comprising the steps of:
providing a label for selling with a product, said label having a first side including a first authentication code unique to said product printed on the first side, wherein said first authentication code is least partially concealed by a tamper evident seal;
removing tamper-evident seal to reveal the first authentication code;
reading all of said first authentication code using means for uniquely identifying and verifying the authenticity of the product.

18. A system for facilitating the verification of authenticity of a product, said system comprising:
a product authenticator as referred to in the first aspect of the invention above;
scanning means configured to read said first product authentication code, said scanning means including means for communicating with a computer network;
a server connected to scanning means over the computer network, said server configured to receive first product authentication code data from scanning means and identify and verify the authenticity of the product.

19. The system of claim 18 wherein said server receiving first product authentication code data from scanning means results in the expiry of said first product authentication code, such that if the server subsequently received the same first product authentication code, the server sends a notification that the first authentication code has expired.

20. The system of claim 18 wherein said scanning means is associated with a user and is configured to send user-specific information to said server upon reading said first product authentication code, wherein said server utilises said user-specific information to create a unique marketing profile for the user.

21. The system of claim 20 wherein said user-specific information comprises an IP address, user credentials, and social network credentials.

22. The system of claim 18 wherein said scanning means is configured to send location data regarding the location of the scanning means to the decoding server once a first product authentication code has been read and said server is configured to record the time and date the location data was received.

23. The system of claim 18 wherein said scanning means is configured to allow a user to input a review of the product once a first product authentication code has been read.

24. The system of claim 18 wherein said scanning means is a mobile device configured to share on a computer network the fact that a product has been consumed by the user once a first product authentication code has been read.

25. The system of claim 18 wherein said computer network comprises a social network including personal connections of a user, and the fact that a product has been consumed by the user is shared with the personal connections of a user only.

26. The system of claim 18 wherein said scanning means is a mobile device configured to detect mobile devices owned by other personal connections of a user within a pre-determined range and share on a social network which personal connections were within a pre-determined range when a first product authentication code has been read.

27. The system of claim 18 wherein said scanning means is configured to allow a user to enter a promotional contest once said first product authentication code has been read.
